(19) United States
(12) Patent Application Publication
(10) Pub. No.: US 2016/0042611 A1
(43) Pub. Date: Feb. 11, 2016

(54) SOCIAL MEDIA INTERACTION SYSTEM AND METHOD

(71) Applicant: LOTTOLIKES LLC, Davie, FL (US)

(72) Inventors: Ryan Abrahams, Davie, FL (US); Chase Gale, Davie, FL (US)

(73) Assignee: LOTTOLIKE LLC, Davoe, FL (US)

(21) Appl. No.: 14/822,591

(22) Filed: Aug. 10, 2015

Related U.S. Application Data
(60) Provisional application No. 62/035,239, filed on Aug. 8, 2014.

(51) Int. Cl. G07F 17/32

(52) U.S. Cl. CPC G07F 17/3286; G07F 17/323; G07F 17/3244

(57) ABSTRACT

Systems and methods are disclosed that enable or facilitate a word association interaction between users. In some embodiments, a list of words may be presented to a user, who creates a sentence using one or more of the words. Sentences may be scored or rated by a reviewing user, and accumulated scores may be selectively distributed to users or groups of users. In other embodiments, a registered account at a provider may be synchronized with an identified registered account at a social media platform, and the provider may aggregate approval data based upon user interaction with content on the platform; these data may be used by the provider to host contests or to provide business intelligence information to the platform.

### CROSS-REFERENCE TO RELATED APPLICATIONS

This application claims the benefit of U.S. provisional patent application Ser. No. 62/035,239, filed Aug. 8, 2014, the entire contents of which are herein incorporated by reference.

### FIELD OF THE DISCLOSURE

Aspects of this disclosure relate generally to computer applications and, more particularly to a social media interaction system and method that may be used in a social media environment.

### BACKGROUND

Social media may be broadly defined as the various fora or digital environments in which networks or groups of individuals may interact with one another, particularly through online or mobile computer applications. These digital environments generally permit users participating in the social media to express themselves, usually by posting content to a common forum. Other users typically may be enabled to view the original user's posted content, and may, in some instances, be enabled to provide comments, editorialization, annotation, or additional content to be associated with the original user's posted content. In this manner, users may connect, provide updates on personal or professional life events, post photographs, view or receive such information from others, or otherwise interact with other users. Computer-implemented social media applications have become extremely popular, particularly those applications used with mobile devices. Due at least in part to their popularity and large user base, these applications provide tremendous business potential. The more users who participate in a social media platform, the more users are exposed to advertising, which is an important factor that can drive revenue for companies. One shortcoming associated with typical social media platforms, however, is that the methods or mechanisms available that enable advertisers to interact with the users of a particular platform are limited, both in number and in functionality. Current advertisement paradigms are generally limited to advertising content (such as a graphic image, splash page, banner or pop-up ad, video commercial, and the like) that appears or is displayed when a user invokes the application or otherwise navigates to a particular forum; the user is obligated to view the advertising content before continuing use of the application or entering the forum. This passive advertising technique is not artfully integrated with the forum or the social media application, fails to engage the user as part of the social media experience, and is thought by many users to be an inefficient nuisance.

### SUMMARY

Embodiments described herein overcome the above-mentioned and various other shortcomings of conventional technology, providing a word association system and method that engages users and advertisers in a manner that does not interrupt or dominate the user experience.

The following represents a simplified summary that is provided to facilitate a basic understanding of some aspects of the invention. This summary is not an extensive overview of the invention. It is intended neither to identify key or critical elements of the invention nor to delineate the scope of the invention; its sole purpose is to present some concepts of the invention in a simplified form as a prelude to the more detailed description that is presented later.

In accordance with one embodiment, the present disclosure describes a computer-implemented method enabling a word association interaction between users. The method generally comprises presenting a list of words to a user, receiving a sentence from the user and verifying that the sentence satisfies a verification criterion, responsive to the verifying, displaying the sentence to a reviewing user, accumulating score data received from the reviewing user and associated with the sentence, and selectively distributing the score data.

In accordance with another embodiment, the present disclosure describes a computer-implemented method enabling competitive interaction between users. The method generally comprises registering a user by establishing a registered user account, synchronizing the registered user account with an identified account at a social media platform associated with the user, associating the user with a particular contest, accumulating score data responsive to user interactions at the social media platform, and selectively distributing the score data and an award upon termination of the contest.

The following description and the appended drawings set forth in detail certain illustrative aspects of the invention. These aspects are indicative, however, of but a few of the various ways in which the principles of the invention may be employed and the present invention is intended to include all such aspects and their equivalents. Other advantages and novel features of the invention will become apparent from the following detailed description of the invention when considered in conjunction with the appended drawing figures.

### BRIEF DESCRIPTION OF THE DRAWING FIGURES

FIG. 1 is a block diagram illustrating a prior art portable multifunction device with a touch-sensitive display modified to include some functionality of the present invention.

FIG. 2 is a simplified illustration of a user interface displayed in accordance with one embodiment of a social media system and method.

FIG. 3 is a simplified illustration of a sentence rating user interface displayed in accordance one embodiment of a social media system and method.

FIG. 4 is a simplified illustration of a registration user interface displayed in accordance with one embodiment of a social media system and method.

FIG. 5 is a simplified illustration of a leaderboard user interface displayed in accordance with one embodiment of a social media system and method.

FIG. 6 is a simplified flow diagram illustrating the operational flow of one embodiment of a word association social media method.

FIG. 7 is a simplified block diagram illustrating a social media environment in accordance with an embodiment.

FIG. 8 is a simplified flow diagram illustrating operational flow of one embodiment of a social media system.

### DETAILED DESCRIPTION

The following detailed description and the appended drawing figures describe and illustrate some embodiments of the invention for the purpose of enabling one of ordinary skill in the relevant art to make and use the invention. As such, the detailed description and illustrations of these embodiments are purely illustrative in nature and are in no way intended to limit the scope and contemplation of the invention, or its protection, in any manner. It should also be understood that the drawings are not to scale and in certain instances details have been omitted, which are not necessary for an understanding of the present invention, such as details of fabrication and assembly methods or techniques. In the accompanying drawing figures, like numerals generally represent like components.

The various hardware and other components described below, for example, various modules, hardware or firmware elements, or components and controllers associated therewith, may be implemented as part of one or more computers or processors. As is generally known, a computer or processor may include, depending upon specific implementation details, a computing device such as a microprocessor or microcontroller, an input device, a display, and an interface, for example, for accessing the Internet. A microprocessor and its attendant peripheral devices, controllers, and interfaces may be connected to a communication bus. Typically, a computer or processor may also include a memory or storage element, which may be embodied in or comprise Random Access Memory (RAM) elements, Read Only Memory (ROM) elements, any of a number of derivatives or variations thereof, or a combination of these and other types of components that are configured and operative to store data and digital instruction sets. Additionally, a computer or processor may also include or be coupled to a storage device, which may be a hard disk drive or a device embodied in or operating in cooperation with removable storage media, such as an optical disk drive, a solid state disk drive (e.g., flash RAM), and the like. A storage device may also be embodied in or comprise similar devices or components for loading computer programs or other instructions into the computer or processor.

In addition to the high-level description above, it will be appreciated by those of skill in the art that, as used herein, the term “computer” or “module” may include any processor-based or microprocessor-based system including systems using microcontrollers, reduced instruction set computer (RISC) processors, application specific integrated circuits (ASICs), field-programmable gate arrays (FPGAs), graphical processing units (GPUs), logic circuits, and any other circuit or processing element capable of executing the functions described herein. The above examples are representative only, and are thus not intended to limit in any way the definition and/or meaning of the terms “computer” and “module.”

In operation, a computer or processor executes a set of instructions that are stored in one or more storage elements (or memory, as described above), in order to process input data. Storage elements may also store data or other information as desired or needed, and may generally be implemented in the form of an information source or a physical memory element within a processing machine or operably coupled thereto via a suitable interface or memory controller element.

In the context of a computer system as set forth herein, a set of instructions may include various commands that instruct the computer or processor as a processing machine to perform specific operations such as the methods and processes of the various embodiments of the invention. The set of instructions may be in the form of a software program, which may form part of a tangible, non-transitory computer readable medium or media. Software may be implemented or embodied in various forms such as system software or application software. Further, software may be in the form of a collection of separate programs or modules, a program module within a larger program, or a portion of a program module. Software also may include modular programming in the form of object-oriented programming. At runtime, or otherwise during operation, processing of data by the processing machine may be in response to operator commands, in response to interrupts, no-ops, or other machine commands issued by the processor internally, in response to results of previous processing or interim results, or in response to a request made by another processing machine or software call.

As used herein, the terms “software,” “firmware,” and “algorithm,” are interchangeable, and include any computer program stored in memory for execution by a computer, including RAM memory, ROM memory, EPROM memory, EEPROM memory, non-volatile RAM (NVRAM) memory, and other memory elements using different memory technologies or standards. The above memory types are representative only, and are thus not limiting as to the types of memory usable for storage of a computer program.

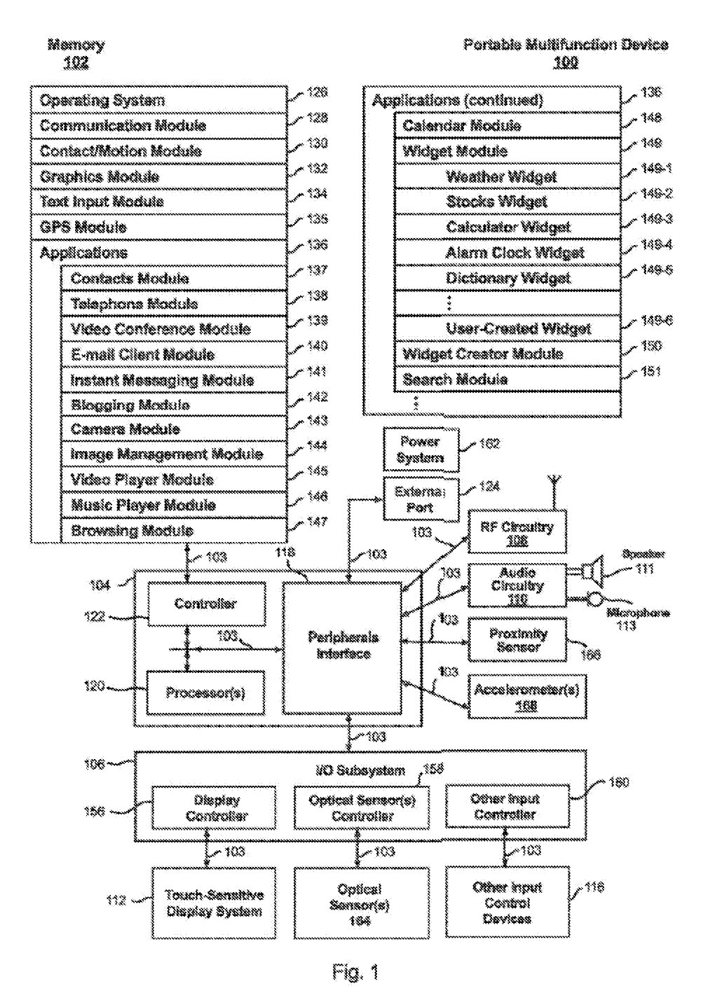

FIG. 1 is a block diagram illustrating a prior art portable multifunction device 100 with a touch-sensitive display 112 modified to include some functionality of the present invention. The touch-sensitive display 112 is also known in the art as a touch screen or a touch-sensitive display system. The device 100 may include a memory 102 (which may include one or more computer readable storage media), a memory controller 122, one or more processing units (CPUs) 120, a peripherals interface 118, radio frequency (RF) circuitry 108, audio circuitry 110, a speaker 111, a microphone 113, an input/output (I/O) subsystem 106, other input or control devices 116, and an external port 124. The device 100 may include one or more optical sensors 164. These components may communicate over one or more communication buses or signal lines 103.

It will be appreciated that the illustrated version of device 100 is only one example of a portable multifunction device 100 that may be used to execute the system and method of the present invention, and that device 100 may have more or fewer components than shown, may combine two or more components, or may have a different configuration or arrangement of the components than that shown in FIG. 1. The various components depicted in FIG. 1 may be implemented in hardware, firmware, software, or a combination of these, and may include one or more digital signal processing (“DSP”) circuits, application specific integrated circuits (“ASICs”), or other hardware elements or components.

Memory 102 may include high-speed random access memory and may also include non-volatile memory, such as one or more magnetic disk storage devices, flash memory devices, or other non-volatile solid-state memory devices. Access to memory 102 by other components of device 100, such as CPU 120 and peripherals interface 118, may be controlled by memory controller 122, as is generally known.

Peripherals interface 118 couples the input and output peripherals of device 100 to CPU 120 and memory 102. The one or more processors 120 run or execute various software programs and/or sets of instructions stored in memory 102 to perform or otherwise to enable various functions (i.e., to execute or to enable applications) for device 100 and to process data.

Peripherals interface 118, CPU 120, and memory controller 122 may be implemented on a single chip, such as a chip 104. These components and others may also be implemented on separate chips as necessary or desired.

Transceiver circuitry 108 receives and sends electromagnetic signals. A person of ordinary skill in the art will recognize that these signals are conventionally referred to as radio frequency (“RF”) signals in the context of portable devices, regardless of whether the signals fall within what is conventionally known as the radio spectrum. In that regard, the terms “transceiver circuitry” and “RF circuitry” are used interchangeably in the present application.

RF circuitry 108 converts electrical signals to/from electromagnetic signals and communicates information to and from communications networks and other communications devices by modulating/demodulating electromagnetic signals with data corresponding to the information. RF circuitry 108 may include circuitry known in the art for performing these functions, including but not limited to an antenna system, one or more amplifiers, filters, a tuner, one or more oscillators, a digital signal processor, a CODEC chipset, modulator/demodulator, a subscriber identity module (SIM) card, memory, and so forth. RF circuitry 108 may communicate with any of various networks, such as the Internet, an intranet and/or a wireless network (such as a cellular telephone network, a wireless local area network (LAN) and/or a metropolitan area network (MAN)), and other devices or communications components via known wireless communications standards or protocols. The wireless communication may use any of a plurality of communications standards, protocols, and technologies, including but not limited to Global System for Mobile Communications (GSM), Enhanced Data GSM Environment (EDGE), high-speed downlink packet access (HSDPA), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g and/or IEEE 802.11n), voice over Internet Protocol (VoIP), Wi-MAX, a protocol for email (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), and/or Instant Messaging and Presence Service (IMPS)), and/or Short Message Service (SMS), or any other suitable communication protocol, including communication protocols not yet developed as of the filing date of this application.

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data may be retrieved from and/or transmitted to memory 102 and/or RF circuitry 108 by peripherals interface 118. Audio circuitry 110 may also include a headset jack. The headset jack provides an interface between audio circuitry 110 and removable audio input/output peripherals, such as output-only headphones or a headset with both output (e.g., a headphone for one or both ears) and input (e.g., a microphone).

I/O subsystem 106 couples input/output peripherals on device 100, such as touch screen 112 and other input/control devices 116, to peripherals interface 118. I/O subsystem 106 may include a display controller 156 and one or more input controllers 160 for other input or control devices. The one or more input controllers 160 receive/send electrical signals from/to other input or control devices 116. The other input/control devices 116 may include physical buttons (e.g., push buttons, rocker buttons, etc.), dials, slider switches, joysticks, click wheels, and so forth. Input controller(s) 160 may also be coupled to any (or none) of the following: a keyboard, infrared port, USB port, and a pointer device such as a mouse or a trackpad.

Touch-sensitive touch screen 112 provides an input interface and an output interface between device 100 and a user. Display controller 156 receives and/or sends electrical signals from/to touch screen 112. Touch screen 112 displays visual output to the user. Such visual output may include graphics, text, icons, video, and any combination thereof (collectively termed “graphics”).

Touch screen 112 has a touch-sensitive surface, sensor or set of sensors that accepts input from the user through tactile contact. Touch screen 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, icons, web pages, or images, for instance) that are displayed on touch screen 112. For example, a point of contact between touch screen 112 and the user corresponds to a finger of the user disposed on or making contact with a surface of touch screen 112.

Touch screen 112 may use liquid crystal display (LCD) technology, or light emitting polymer display (LPD) technology, although other display technologies may also be used. Touch screen 112 and display controller 156 may detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112.

Device 100 also includes a power system 162 for powering the various components such as illustrated in FIG. 1. Power system 162 may include a power management system, one or more power sources (e.g., battery, or alternating current (AC) source), a recharging system, a power failure detection circuit, a power converter or inverter, a power status indicator (e.g., a light-emitting diode (LED) or other battery capacity indicum) and any other components associated with the generation, management, and distribution of power in portable devices.

Device 100 may also include one or more optical sensors 164. FIG. 1 shows an optical sensor 164 that is coupled to an optical sensor controller 158 in I/O subsystem 106. Optical sensor 164 may include charge-coupled device (CCD) or complementary metal-oxide semiconductor (CMOS) phototransistors. In operation, optical sensor 164 receives light from the environment, projected through one or more lenses, and converts received light to data representing an image. In conjunction with an imaging module 143 (also called a camera module), optical sensor 164 may capture still images or video. In some implementations, optical sensor 164 may be located on the back of device 100, opposite touch screen display 112 on the front of the device, so that touch screen display 112 may be used as a viewfinder for either still and/or video image acquisition. Additionally or alternatively, an optical sensor 164 may be located on the front of device 100 so that the user's image may be obtained for videoconferencing while the user views the other video conference participants on touch screen display 112. Preferably, the position of optical sensor 164 can be selectively changed by the user (e.g., by rotating the lens and the sensor in the device housing) so that a single optical sensor 164 may be used along with touch screen display 112 for both video conferencing and still and/or video image acquisition.

Device 100 may also include one or more proximity sensors 166. FIG. 1 shows a proximity sensor 166 coupled to peripherals interface 118. Alternately, proximity sensor 166 may be coupled to an input controller 160 in I/O subsystem 106. Proximity sensor 166 may be used to turn off and disable touch screen 112 when multifunction device 100 is placed near the user's ear (e.g., when the user is making a phone call). Proximity sensor 166 may also be used to disable touch screen display 112 when device 100 is not in use, such as for instance, when device 100 is in the user's pocket, purse, or other dark area, to prevent unnecessary battery drainage when device 100 is in a locked state or is otherwise not in use.

Device 100 may also include one or more accelerometers 168. FIG. 1 shows an accelerometer 168 coupled to peripherals interface 118. Alternately, accelerometer 168 may be coupled to an input controller 160 in I/O subsystem 106. Accelerometer 168 generally captures data that is analyzed to determine whether to change a view of information, for example from portrait to landscape, displayed on touch screen display 112 of portable device 100.

The software components stored in memory 102 may include an operating system 126, a communication module (or set of instructions) 128, a contact/motion module (or set of instructions) 130, a graphics module (or set of instructions) 132, a text input module (or set of instructions) 134, a Global Positioning System (GPS) module (or set of instructions) 135, and applications (or set of instructions) 136.

In operation, operating system 126 (e.g., Darwin, RTXC, LINUX, UNIX, OS X, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or the external port 124. External port 124 (e.g., Universal Serial Bus (USB), FIREWIRE, etc.) is adapted for coupling directly to other devices or communicating indirectly to other devices over a network (e.g., the Internet, wireless LAN, etc.).

Contact/motion module 130 may detect contact with touch screen display 112 (in conjunction with display controller 156, for instance) and other touch sensitive devices (e.g., a touchpad or physical click wheel). Contact/motion module 130 generally includes various software components for performing various operations related to detection of contact, such as determining if contact has occurred, determining if there is movement of the contact, and tracking the movement across touch screen display 112, and determining if the contact has been broken (i.e., if the contact has ceased). Determining movement of the point of contact may include determining speed (magnitude), velocity (magnitude and direction), and/or an acceleration (a change in magnitude and/or direction) of the point of contact. These operations may be applied to single contacts (e.g., one finger contacts) or to multiple simultaneous contacts (e.g., “multitouch”/multiple finger contacts). Alternatively, contact/motion module 130 and controller 160 may detect contact on a click wheel or other input device, for example.

Graphics module 132 includes various known software components for rendering and displaying graphics on touch screen display 112, including components for changing the intensity of graphics that are displayed. As used herein, the term “graphics” includes any object that can be displayed to a user, including without limitation text, web pages, icons (such as user-interface objects including soft keys), digital images, videos, animations, and the like.

Text input module 134, which may be a component of graphics module 132, provides soft keyboards for entering text in various applications (e.g., contacts 137, e-mail 140, IM 141, blogging 142, browser 147, and any other application that request or require text input).

GPS module 135 determines the location of device 100 and provides this information for use in various applications (e.g., to telephone 138 for use in location-based dialing, to camera 143 and/or blogger 142 as picture/video metadata, and to applications that provide location-based services such as weather widgets, local yellow page widgets, and map/navigation widgets).

The applications 136 may include the following modules (or sets of instructions), or a subset or superset thereof: a contacts module 137 (sometimes called an address book or contact list); a telephone module 138; a video conferencing module 139; an e-mail client module 140; an instant messaging (IM) module 141; a blogging module 142; a camera module 143 for still and/or video images; an image management module 144; a video player module 145; a music player module 146; a browser module 147; a calendar module 148; a widget modules 149, which may include weather widget 149-1, stocks widget 149-2, calculator widget 149-3, alarm clock widget 149-4, dictionary widget 149-5, and other widgets obtained by the user, as well as user-created widgets 149-6; widget creator module 150 for making user-created widgets 149-6; search module 151; video and music player module, which merges video player module 145 and music player module 146; notes module; and/or map module; and/or online video module.

Examples of other applications 136 that may be stored in memory 102 include other word processing applications, JAVA-enabled applications, encryption, digital rights management, voice recognition, and voice recognition or voice replication.

In conjunction with touch screen display 112, display controller 156, contact module 130, graphics module 132, and text input module 134, the contacts module 137 may be used to manage an address book or contact list, including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone 138, video conference 139, e-mail 140, or IM 141; and so forth.

In conjunction with RF circuitry 108, audio circuitry 110, speaker 111, microphone 113, touch screen display 112, display controller 156, contact module 130, graphics module 132, and text input module 134, the telephone module 138 may be used to enter a sequence of characters corresponding to a telephone number, access one or more telephone numbers in the address book 137, modify a telephone number that has been entered, dial a respective telephone number, conduct a conversation and disconnect or hang up when the conversation is completed. As noted above, the wireless communication may use any of a plurality of communications standards, protocols and technologies.

In conjunction with RF circuitry 108, audio circuitry 110, speaker 111, microphone 113, touch screen display 112, display controller 156, optical sensor 164, optical sensor controller 158, contact module 130, graphics module 132, text input module 134, contact list 137, and telephone module 138, the videoconferencing module 139 may be used to initiate, conduct, and terminate a video conference between a user and one or more other participants.

In conjunction with RF circuitry 108, touch screen display 112, display controller 156, contact module 130, graphics module 132, and text input module 134, the e-mail client module 140 may be used to create, send, receive, and manage e-mail. In conjunction with image management module 144, e-mail module 140 makes it easy to create and send e-mails with still or video images taken with camera module 143.

In conjunction with RF circuitry 108, touch screen display 112, display controller 156, contact module 130, graphics module 132, and text input module 134, the instant messaging module 141 may be used to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages.

In conjunction with RF circuitry 108, touch screen display 112, display controller 156, contact module 130, graphics module 132, text input module 134, image management module 144, and browsing module 147, the blogging module 142 may be used to send text, still images, video, and/or other graphics to a blog (e.g., the user's blog).

In conjunction with touch screen display 112, display controller 156, optical sensor(s) 164, optical sensor controller 158, contact module 130, graphics module 132, and image management module 144, the camera module 143 may be used to capture still images or video (including a video stream) and store same into memory 102, modify characteristics of a still image or video, or delete a still image or video from memory 102.

In conjunction with touch screen display 112, display controller 156, contact module 130, graphics module 132, text input module 134, and camera module 143, image management module 144 may be used to arrange, modify or otherwise manipulate, label, delete, present (e.g., in a digital slide show or album), and store still and/or video images.

In conjunction with touch screen display 112, display controller 156, contact module 130, graphics module 132, audio circuitry 110, and speaker 111, the video player module 145 may be used to display, present, or otherwise to play back videos (e.g., on touch screen display 112 or on an external, connected display via external port 124).

In conjunction with touch screen display 112, display system controller 156, contact module 130, graphics module 132, audio circuitry 110, speaker 111, RF circuitry 108, and browser module 147, music player module 146 allows a user to download and play back recorded music and other sound files stored in one or more file formats, such as MP3 or AAC files.

In conjunction with RF circuitry 108, touch screen display 112, display system controller 156, contact module 130, graphics module 132, and text input module 134, browser module 147 may be used to browse the Internet, including searching, linking to, receiving, and displaying web pages or portions thereof, as well as attachments and other files linked to web pages.

In conjunction with RF circuitry 108, touch screen display 112, display system controller 156, contact module 130, graphics module 132, text input module 134, e-mail module 140, and browser module 147, calendar module 148 may be used to create, display, modify, and store calendars and data associated with calendars (e.g., calendar entries, to do lists, etc.).

In conjunction with RF circuitry 108, touch screen display 112, display system controller 156, contact module 130, graphics module 132, text input module 134, and browser module 147, widget modules 149 are mini-applications that may be downloaded and used by a user (e.g., weather widget 149-1, stocks widget 149-2, calculator widget 149-3, alarm clock widget 149-4, and dictionary widget 149-5) or created by the user (e.g., user-created widget 149-6). A widget may include an HTML (Hypertext Markup Language) file, a CSS (Cascading Style Sheets) file, and a JavaScript file. A widget may also include an XML (Extensible Markup Language) file and a JavaScript file (e.g., Yahoo! Widgets).

In conjunction with RF circuitry 108, touch screen display 112, display system controller 156, contact module 130, graphics module 132, text input module 134, and browser module 147, widget creator module 150 may be used by a user to create widgets (e.g., turning a user-specified portion of a web page into a widget).

In conjunction with touch screen display 112, display system controller 156, contact module 130, graphics module 132, and text input module 134, the search module 151 may be used to search for text, music, sound, image, video, and/or other files in memory 102 that match one or more search criteria (e.g., one or more user-specified search terms).

In conjunction with touch screen display 112, display controller 156, contact module 130, graphics module 132, and text input module 134, a notes module may be used to create and manage notes, to do lists, and the like.

In conjunction with RF circuitry 108, touch screen display 112, display system controller 156, contact module 130, graphics module 132, text input module 134, GPS module 135, and browser module 147, a map module may be used to receive, display, modify, and store maps and data associated with maps (e.g., driving directions; data on stores and other points of interest at or near a particular location; and other location-based data).

In conjunction with touch screen display 112, display system controller 156, contact module 130, graphics module 132, audio circuitry 110, speaker 111, RF circuitry 108, text input module 134, e-mail client module 140, and browser module 147, an online video module allows the user to access, browse, receive (e.g., by streaming and/or download), play back (e.g., on touch screen display 112 or on an external, connected display via external port 124), send an e-mail with a link to a particular online video, and otherwise manage online videos in one or more file formats, such as H.264. In other modes of operation, instant messaging module 141, rather than invoking e-mail client module 140, may be employed to send a link to a particular online video.

It will be appreciated that each of the above identified modules and applications corresponds to a set of instructions for performing one or more functions described above. These modules or applications (i.e., sets of instructions) need not be implemented as separate software programs or procedures, and thus various subsets of these modules may be combined or otherwise re-arranged in various embodiments. For example, video player module 145 may be combined with music player module 146 into a single module or application (e.g., video and music player module). Memory 102 may store a subset of the modules and data structures identified above. Furthermore, memory 102 may store additional modules and data structures not described above.

Device 100 may be embodied in or comprise a device in which operation of a predefined set of functions on the device 100 is performed exclusively through touch screen display 112 and/or a touchpad. By using touch screen display 112 and/or a touchpad as the primary input/control device for operation of device 100, the number of physical input/control devices (such as push buttons, dials, and the like) on device 100 may be reduced.

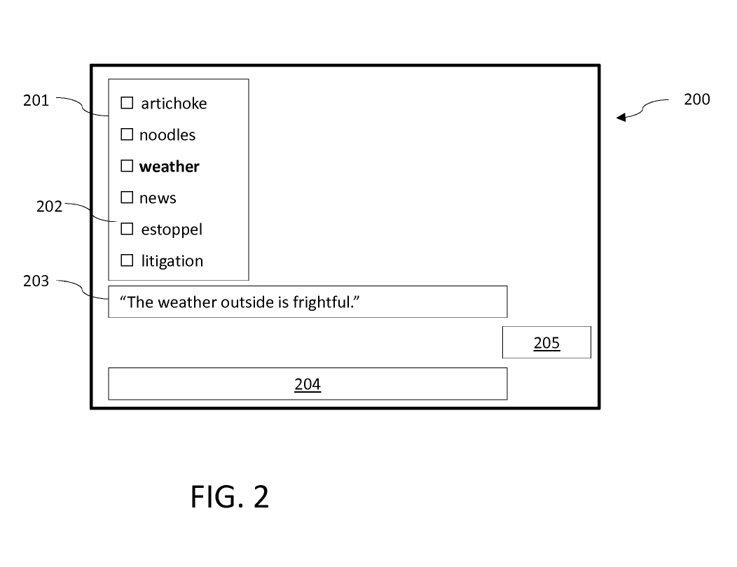

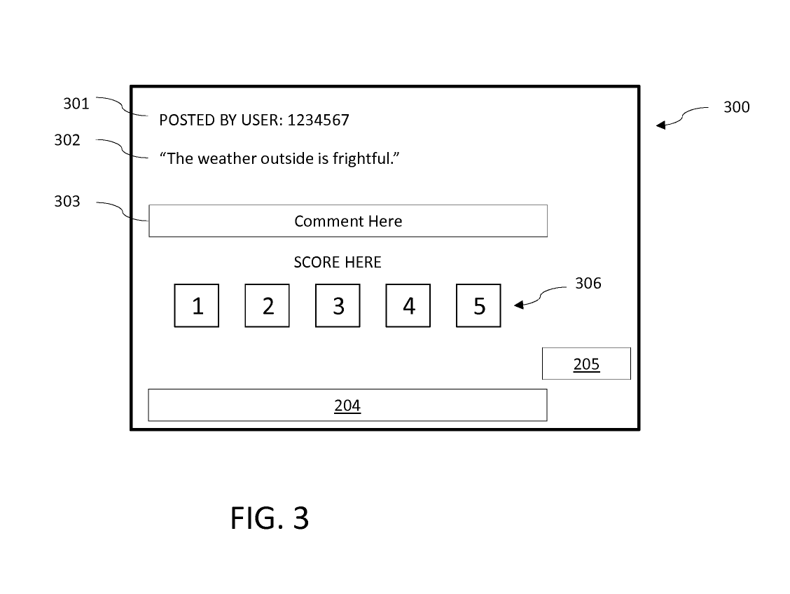

With reference now to FIGS. 2 and 3, various embodiments of an interactive social media system and method are provided in accordance with the disclosure and may be invoked, run, instantiated, or executed on embodiments of portable device 100 or other computing system. It should be appreciated that descriptions of embodiments as set forth herein are non-limiting and contemplate both preferred and alternative embodiments of the disclosed system and method.

FIG. 2 is a simplified illustration of a user interface displayed in accordance with one embodiment of a social media system and method. The social media system and method may include a word association game or program displayed (such as on touch-sensitive display 112) in a user interface such as depicted at 200. When the word association game is operating, in some instances, a user may be presented or provided with a plurality of words; the words may be presented as a simple list, such as illustrated at 201 in FIG. 2, or in a drop-down menu, rotating or three-dimensional graphical display, or other suitable user-interface construct. The user may be prompted or requested to select one of the words presented. The user may select one of the word options, for instance, by touching, tapping, or otherwise selecting the word (represented by the highlighted word at 201) or some appropriate user-interface element associated with the word (such as a check box 202 or radio button, for example), and generate a sentence which includes the selected word. In some embodiments, the user may enter the sentence in a text field 203 or other suitable mechanism. For instance, if the user selects the word “weather” from list 201 presented or provided, the user may then generate a sentence including that word, such as “The weather outside is frightful,” or “My brother and I are hoping for beach weather today” in field 203. The user may input or enter the sentence using an appropriate key board, softkey pad, or touch-sensitive display 112 element (such as illustrated at 204).

In some embodiments, proposed words provided in list 201 may be divided into categories having relevance with respect to cultural issues, news or current events, sports, entertainment, history, or other themes. For example, in FIG. 2, the top two words may be associated with a “food or cuisine” category, the middle two words may be associated with a “current events” category, and the bottom two words may be associated with a “legal” category. In FIG. 2, words from multiple categories are displayed in list 201 simultaneously, but in some instances, users may select (via a dropdown menu, checklist, or other selection vehicle) categories of words to view such that only words from a particular category or categories are presented for selection and sentence construction. It is noted also that a word may associated with more than one category; for example, the word “weather” may be classified, characterized, or otherwise associated with a “current events” category as well as a “science” category and a “nature” category.

In some embodiments, a large number of words may be provided, including necessary nouns, verbs, conjunctions, adjectives, etc. to generate a complete sentence exclusively using the presented words; in this instance, the user may be enabled to select any of those words or, alternatively, must select one special word to use with the other presented words exclusively. For instance, the presented words may include “a,” “dog,” “happy,” “ran,” “lick,” and “quickly,” and the user may generate the possible sentence: “a happy dog ran quickly.” The user may be required to use all of the presented words, or a predetermined number of the presented words, including only a single presented word (as illustrated in the FIG. 2 embodiment).

In some embodiments, a game, or a round in a game, may be time-limited. As an example, users may be required or allowed to generate only a single sentence in predetermined time period, e.g., a turn or round in the game. In some implementations, such a predetermined time period may be a day, though shorter or longer periods are contemplated. In other implementations, it may be desirable to allow users to generate more than one sentence per predetermined time period, and it may also be desirable to allow the users themselves to select both the predetermined time period and the number of sentences on a game-by-game basis.

Users may post, transmit, upload, or otherwise communicate completed sentences entered into field 202 to a forum or other social media environment. As is generally known, such posting may be accomplished by touching, tapping, or otherwise selecting a “post” or “send” user interface element such as indicated at reference numeral 205 in FIG. 2. In some embodiments, it may be necessary or desirable to require a use to enter a specific address or other identifier associated with a particular social media platform; alternatively, a user may be enabled to select from two or more social fora, or may preprogram user interface element 205 such that one selection (i.e., one user interaction) posts the completed sentence to a pre-selected social media forum.

FIG. 3 is a simplified illustration of a sentence rating user interface displayed in accordance with one embodiment of a social media system and method. Upon posting, a sentence may be transmitted via a social media platform such that it may be viewed by third party users (each of whom may be referred to as a reviewing user). In that regard, a sentence posted by a user may be displayed via a user interface 300, for example, on touch-sensitive display 112 associated with or coupled to another user's device (such as device 100). As indicated in FIG. 3, a posting user may be identified as indicated at 301, along with the posted sentence 302. In some embodiments, the identity of the posting user may be obscured, scrambled, encrypted, or omitted, for example, until a score (306) is posted for sentence 303. Some users may opt to use screen-names, pseudonyms, or other anonymizer techniques. User interface may optionally comprise a field 303 accommodating or allowing a reviewing user to enter and post text, links, or other comments, for example, using an appropriate key board, softkey pad, or touch-sensitive display 112 element (such as illustrated at 204). In some embodiments, each reviewing user may assign a point value 306 to each posted sentence, for example, by touching or tapping a particular selected score; alternatively, a drop-down menu, check boxes, text or alphanumeric fields, or other mechanism may be employ to facilitate score entry. In other embodiments, while all users may review other users' sentence postings, the foregoing scoring or rating functionality may be limited to or reserved for certain users (for example, users who have been registered or active participants for a certain period of time, users who have paid a monthly fee, or users who have satisfied other criteria). When a score 306 is entered or selected and any optional comments are entered in field 303, a user may post or transmit same by touching, tapping, or otherwise selecting a “post” or “send” user interface element such as indicated at reference numeral 205.

Although point assignments or scores 306 are discretionary in nature, it is contemplated that a user who posts a creative or unique sentence will generally receive more points (or a higher score 306) as judged by reviewing users (e.g., those reviewing users who are authorized to provide scores, points, or ratings) than a user who posts an ordinary or bland sentence. In one embodiment, sentence 302 may receive a score 306 between one and five points from reviewing users; other point or score ranges are contemplated, and may be more appropriate under certain circumstances, and it may be desirable to make such a point range user selectable. Negative or penalty scores 306 are also contemplated, for instance for inappropriate or particularly uncreative sentences. Use of certain presented words (such as in list 201) in sentence 302 may offer bonus points or score 306 multipliers. Such bonus words may be words sponsored by a particular advertiser, for instance, as set forth in more detail below. Additionally or alternatively, bonus words may be words that are generally considered more difficult to include in a sentence, for example, as may be determined by system administrators.

In accordance with some aspects of the disclosed system and method, users receiving a substantial number of points 306 over a period of time may be eligible for prizes or rewards. In this context, a substantial number of points may be measured according to a predetermined threshold or, alternatively, may be determined based on a particular user's accumulated points versus points accumulated by third party users. For instance, a user receiving or accumulating more points than other users within a given time period may be awarded a prize. As is generally known, such prizes may have monetary value (such as gifts, gift cards, or cash) or non-monetary value (such as digital emblems or other recognition).

Of the words presented in list 201, one or more of the words may be advertised or sponsored words, which are offered as one of the plurality of words because a company or individual sponsored that word or paid consideration for its appearance in list 201. In one embodiment, three words may be presented at random, e.g., using random number generation algorithms or other methods, and two additional words in list 201 may be sponsored words; it may be desirable not to display to a user which words in list 201 are sponsored words, though in other embodiments, the sponsored words may be highlighted, emphasized, or otherwise identified. Multiple categories or characterizations of sponsored words are contemplated. For instance, a word in a first category of sponsored words may be called or referred to as a “daily word” or “word of the day.” A word in such a category may be a word which system administrators believe will generate conversation or interaction amongst users. A word in a second category of sponsored words may be called a “bonus word” or “special word.” Words in this category may be less discussed by, or less appealing or interesting to, a majority of users but may be more targeted to specific users having a particular interest in certain topics or subject matter. It will be appreciated that sponsored words may be in multiple categories; for instance, a word may be presented in list 201 on one occasion as a “word of the day,” and subsequently may appear in list 201 as a “bonus word.” Sponsoring entities may pay operators of the social networking platform that hosts the present system and method to have a particular sponsored word appear as one of the plurality of presented words in list 201 from which a user may select to create a sentence.

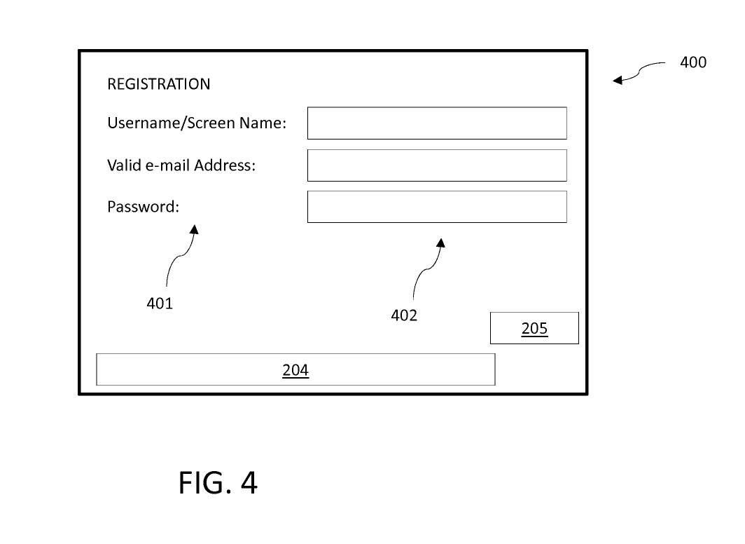

In accordance with aspects of the present system and method, users may initially register by providing personal information including, in one embodiment, a name (or screen name or pseudonym), an e-mail address, and a password. FIG. 4 is a simplified illustration of a registration user interface displayed in accordance with one embodiment of a social media system and method. As indicated in FIG. 4, a user interface 400 may be presented to enable a user to enter requested personal information 401 in associated text or alphanumeric fields 402. As noted above, data may be input using an appropriate key board, softkey pad, or touch-sensitive. display 112 element (such as illustrated at 204).

Though FIG. 4 shows only fields 402 for a few items of personal data 401, other personal information such as age, gender, and location (e.g., home town, city, or state, country, college campus, etc.) may be requested upon registration, either as required data or optional data. Registration may thereby result in generation of a user profile, or dossier, including personal information relating to the registered user. When necessary or desired data are entered or selected, a user may post or transmit same by touching, tapping, or otherwise selecting a “send” or “register” user interface element such as indicated at reference numeral 205.

Once a user is registered, the method may transition to or push a splash or home screen, which may also be the initial screen that is viewable when a previously registered user has logged in. At the home screen, various menu options may be available including, but not limited to, account management features, chat features, group features, sentence listings, challenge features, as well as other features or modules in accordance with embodiments of the disclosure. In addition to displaying a menu for browsing or selecting various features, the home screen may also display the presented word list 201. If a user is dissatisfied with one or more of the presented words, users may have the option to replace one or more of the words, for instance, or request an entirely new list 201 from a particular category of words. In some instances, such a replacement of words from list 201 may require the user to relinquish points that were previously earned; in some cases, this feature may be a premium or “pay” feature that is only available to users who elect to pay for use of the system. Notifications or alerts signaling status changes (such as updates and bug fixes or newly available premium features, for example) or system interruptions within the system may also be displayed on the home screen.

During operation, users may view and rate third party users' submitted posted sentences, as well as generate and publish their own sentences for subsequent rating or scoring by reviewing users as described above with reference to FIG. 2. In some embodiments, users may view and rate currently posted sentences by category. For instance, a user may be able to select one of the presented words from list 201 and view only those third party user sentences submitted that incorporate that particular word. Users may also select words in accordance with other classifications, such as friends, user groups, word categories, or users present on the leaderboard, as described below.

A user may have the option to manage a registered account. Such management may include, for instance, updating or changing profile data, changing account settings or preferences, viewing a leaderboard of users having particularly high scores (either globally or on a per-sentence basis), viewing a history, interacting with challenges, inviting friends, or reviewing available prizes. These and other account management features are readily implemented in a social media application context, and are not intended to limit the scope and contemplation of the present disclosure.

Account management functionality may include, but is not limited to, changing the user's login password, changing preferences, adjusting privacy settings, turning notifications on or off, or logging out of the system. As noted briefly above, it may also be desirable to enable a user to manipulate account settings such that the user may upgrade to a premium, paid, or “pro” version of an application embodying the present system and method. Paid or “pro” versions of the application may be downloadable as an upgrade (i.e., a version that includes enhanced feature sets or functionality) upon payment of a required fee; any of various payment methods and fund transfer mechanisms generally known in the art may be used to accept payment prior to allowing a user access to the upgrade. As noted above, upgraded versions may offer features that are otherwise unavailable; in some circumstances, an upgraded version may reduce or eliminate passive advertisements such as banner ads. For instance, a paid or upgraded version may allow a user to generate multiple sentences, whereas free versions may only allow a user to generate a single sentence within a predetermined time period. Additionally or alternatively, an upgrade may allow users to issue multiple challenges to other users, as described below, whereas a free version may limit users to a materially lower number of challenges in a given time period.

In some embodiments, one or more of the words in list 201 may require purchase in order to be inserted into a user sentence. Such a “paid” word may require a fee before a free user may select it, though in some embodiments, a user having a paid or upgraded version of the system may use such a paid word without paying any additional fee or incurring any additional cost. It will be appreciated that other individual features described herein may be provided on a fee basis per use of the feature.

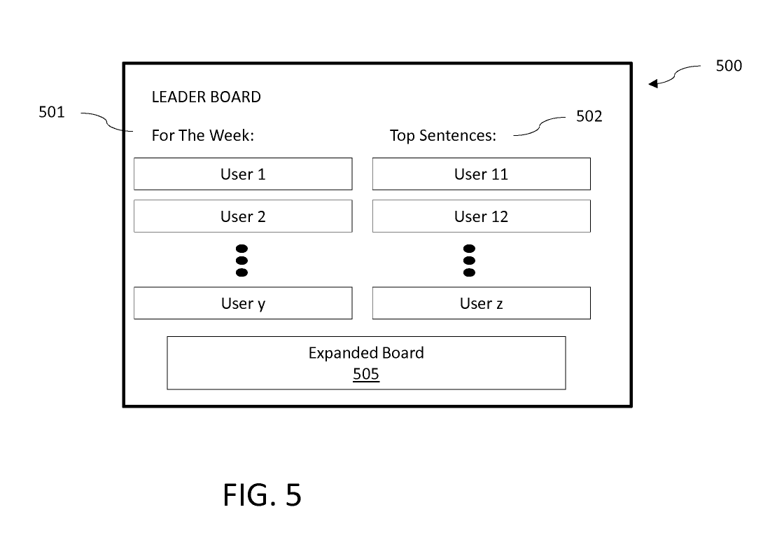

A user may also view a leaderboard, which may display the user's current point value and rank, a number of users currently participating who have the highest current point values, and the like. FIG. 5 is a simplified illustration of a leaderboard user interface displayed in accordance with one embodiment of a social media system and method. User interface 500 may display users 501 (along with certain other profile data) who have top scores for a certain period of time and users 502 (along with certain other profile data) who have top scores for an individual sentence. In some instances, a user may be enabled to view expanded standings (reference numeral 505, for example), including scores or point values for a number of users greater than that initially displayed. As noted above, leaderboards may display or post selected profile information of those users appearing on the leaderboard as top point earners—either for a given time period (501) or for posting a high-scoring sentence for a given word (502), or both. Separate leaderboards may also be provided for friends or connections of the user as well as for groups with which the user is associated.

A user's activity history with the system may also be viewable. Activity history may include previously created sentences, past scores or results for previously created sentences, or the ability to update or revise currently pending sentences. With respect to previously created sentences, it may be possible to view all previously created sentences, only those sentences that have been created within a certain time period (e.g., a predetermined number of days), or only those sentences incorporating certain words or words from certain categories. Scores for active or present day sentences may also be viewable. Optionally, a user may be enabled or allowed to update a pending, submit sentence; in some embodiments, however, such an update may result in forfeiture of the previously accumulated points for the pending sentence. A sentence may remain pending for a predetermined time period, which may be 24 hours, for example, at the end of which the sentence may be locked such that subsequent editing or resubmission is neither permitted nor possible.

A user may challenge a third party user to a contest—the user creating a superior sentence wins, for example. In this regard, as part of the system and method, a user may view pending challenge requests, including user data associated with the third party issuing the challenge. In some instances, a user may view all challenges, past and present. Alternatively, a user may only view active challenges, i.e., only those challenges that have not expired due to lapse of a predetermined period of time or have not been concluded. As noted above, a challenge history may also be viewable, such that a user may be able to view prior challenges and the results thereof. Users may also be provided a subforum or group space in which to seek or solicit challenges from unknown third party users.

As part of these challenges, users may set or agree upon certain conditions of the challenge as well as wager various items as part of the challenge. Items wagered may be taken from each player and placed in trust with as part of a holding account or database, with wagered items distributed to the winner of the challenge upon completion of the challenge. For instance, users may wager previously earned points as part of the challenge, with the winner of the challenge receiving the collective points. Users may also wager previously earned prizes. Gambling is also contemplated within some embodiments, where users may wager real money or other cash-value items as part of their challenges, consistent with relevant policies of the hosting social media platform.

As part of embodiments, a user may further manage the system's interface with other, existing social media platforms. For instance, a user may be able to post sentences, results, leaderboard positions, or other statistics or data from the system to other social media platforms interfaced with or accessible from the system. Users may also invite their connections through other social networking platforms to participate in embodiments of the system, or in limited aspects thereof.

Users may be able to search for third party users on the social media system. Search parameters may be adjustable based upon some or any of the user profile data. Third party users may also be located through communication with existing social networking platforms in order, for instance, to identify members of the user's social network who may be third party users of the social media system. Once identified, users may save, “friend,” or otherwise connect with third party users as desired. In this regard, a friend list may be generated, including third party users with whom the user has associated. A chat or text feature may also be included as part of the social media system. A user may send private messages to third party users, including associated and unassociated third party users. Chatting may be real-time. Additionally, while the chat feature contemplates the inclusion of file sharing or other data sharing, such as multimedia files, some embodiments of the system may restrict the chat feature to text only. Any of various short message service or other text transmission methodologies generally known in the art may be useful for this purpose.

Another feature of the social media system may include the creation of groups with which multiple users may be associated. Users within groups may have a commonality amongst them, such as common location, workplace, social network, or characteristics, as may be reflected in user profile data, for example. A user may generate a group or search for existing groups. Once a user joins a group, the user may challenge other group members to sentence contests. Every group member may be challenged, subsets of the group may be challenged, or individual group members may be challenged. In some embodiments, leaderboard data may reflect top point earners only from within an associated group. Each group may have group identity data, which may include a group name, a group picture, a group description, and a list of group users. The chat feature may also be utilized to send messages to all members of a particular group. It is further contemplated that groups may collectively challenge other groups, where the group whose users collect the greatest number of points is victorious. For group challenges, each group member may submit points for the wagering process or, in some embodiments, a group (collectively) may have points associated with the group as a discrete entity. Where each group has associated points, leaderboard interface 500 may include a feature to display groups (rather than individual users) based on the number of points earned.

The terms “word(s),” “sentence(s),” and other like terms, as used herein, should be defined broadly to include any messages or media content, which may include or be associated with pictures, video, or sounds. For instance, a provided word may be a picture, and users may be able to create sentences which are captions or description of the pictures. In another embodiment, users may also post creative pictures, which may incorporate a presented object into their created pictures.

Privacy features are also contemplated in connection with various embodiments of the social media system. One such feature may be the inclusion of filters during the sentence creation process. For instance, a filtering program may automatically screen out or redact profanity or other undesirable content. Filtering programs may be used in conjunction with user profile data, for example, such that users under a certain age may be restricted from viewing sentences containing mature content. In addition to the filtering program, a spelling or grammar program may operate in order to check spelling or grammar errors before a user submits a sentence for third-party review.

Tracking modules may be included as part of the social media system. These tracking modules may be utilized to track terms that are utilized in creating sentences. For instance, a tracking module may determine the words most commonly used in sentences containing particular words that are presented in list 201. Particularly with respect to sponsored words, this information can be especially valuable to the sponsor. For instance, if a business sponsored its own trademark or trade name as a sponsored word, such a tracking module could determine the most closely associated or most commonly used terms in the sentences posted containing the sponsored word. This tracking methodology offers the ability for system administrators to provide valuable feedback related to overall user perception of various proposed words. Such feedback could be sold to sponsors or otherwise used to monitor or improve public perception. User data may also be tracked and associated with particular words, such that statistical analysis may be performed to determine characteristics or demographical information relating to users selecting and using various presented words. Thus, for instance, the system or a related component may utilize the tracking module to determine a percentage of male or female users selecting each word presented in list 201, or the age range of users selecting particular words.

A back end module may be provided for system administrators to utilize in maintaining and controlling the social media system. Sponsors may be given control of a portion of this back end module. For instance, sponsors may be able to view data associated with sponsored words, such as the number of unique instances of a sentence utilizing the word, or the tracking data associated with the tracking module. As part of the back end module, reports showing statistics of various features of the system may be generated for review by administrators, sponsors, or both.

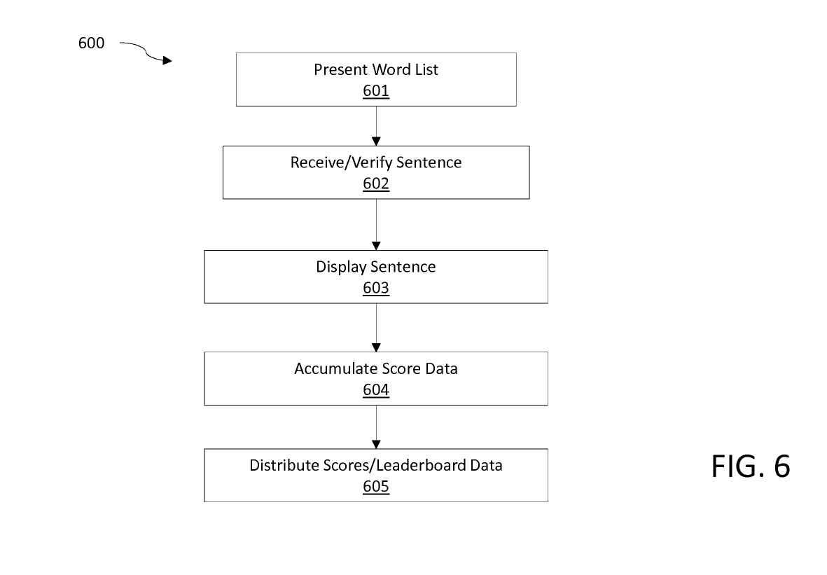

Turning now to FIG. 6 in view of the foregoing detailed description, it will be apparent that FIG. 6 is a simplified flow diagram illustrating the operational flow of one embodiment of a word association social media method. Method 600 may begin, as noted above with reference to FIG. 2, by displaying or presenting a list of words as indicated at block 601. In some disclosed embodiments, presenting may comprise displaying words on touch-sensitive display 112 of device 100, though other embodiments are contemplated employing desk top computers or other devices that are not generally considered “mobile” or that do not include touch-sensitive user interfaces.

Following appropriate user interaction with a user interface, such as set forth in detail above with reference to FIG. 2, method 600 may continue by receiving a sentence as indicated at block 602. A sentence may be uploaded, posted, or otherwise transmitted in accordance with any protocol or methodology suitable for digital or analog communication of data known in the art or developed in accordance with known principles to be received as indicated at 602. Following reception, a sentence may also be verified, i.e., checked or compared against any of various criteria. In that regard, a sentence may be parsed such that inappropriate or offensive content may be stripped; additionally or alternatively, a sentence may be parsed to confirm that it includes a requisite or predetermined number of words presented at 601. In some embodiments, sentences that fail the verification process at 602 may be ignored, in which case method 600 may terminate; alternatively, the source (i.e., a registered user or user device) of the sentence that did not satisfy a verification criterion may be contacted with an error message, which may identify the deficiency that resulted in verification failure.

Upon reception and verification, a sentence may be displayed as indicated at block 603. As with reception at 602, a sentence may be transmitted in accordance with any protocol or methodology suitable for digital or analog communication of data known in the art or developed in accordance with known principles to be displayed on a registered user device (such as device 100, for instance). As described above with specific reference to FIG. 3, method 600 may provide interaction via user interface 300 during the display process 603 enabling a reviewing user to score a sentence, provide comments or feedback, etc. Following appropriate user interaction with such a user interface, method 600 may continue by accumulating score data associated with a sentence as indicated at block 604. Score data may be sent from a registered user device and received in accordance with the communications technologies and protocols set forth above. Score data associated with a particular sentence may be stored for further processing, correlation, archival, etc.

Method 600 may also include selectively distributing score data and associated user profile data as indicated at block 605. Again, such distribution or transmission may employ any suitable telecommunications technology known in the art. In some embodiments or under certain circumstances, the term “distributing” may mean transmitting to an individual or an individual user device, and is not intended to contemplate broad distribution to a large number of entities; in other embodiments, “distributing” may mean transmitting to a vast number of entities, for example, or every registered system user. FIG. 5 illustrates one representation of broadcast data displayed on user interface 500.

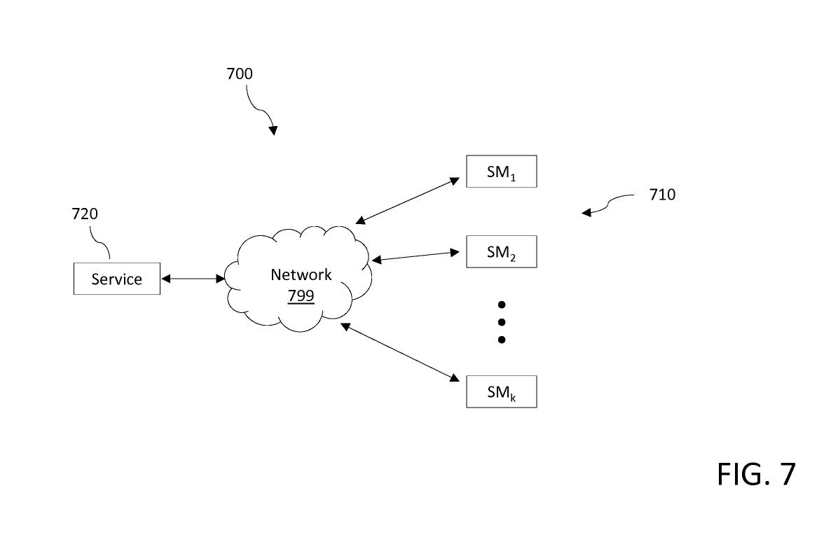

FIG. 7 is a simplified block diagram illustrating a social media environment in accordance with an embodiment. Social media environment 700 may generally include a service provider 720 and social media platforms 710 coupled to a network 799, such as the Internet. In some implementations, some or all of the functionality described above may be hosted on, invoked or instantiated at, or otherwise executed by computer systems or servers at provider 720. In this case, the word association game described above, for example, may use resources at provider 720 to enable or to facilitate some of the features or data processing associated with the game, specifically. In alternative implementations, it may be desirable to host, instantiate, or execute nearly all of the foregoing functionality at platforms 710; in this alternative arrangement, provider 710 may host back-end, data analytics, user scoring, rating, billing, and awards functionality remotely. In particular, it may be desirable to locate the tracking module and the back end module at provider, while off-loading most or all remaining functionality to platforms 710.

In this arrangement, provider 720 may perform or provide back-end, data analytics, user scoring, rating, billing, and awards services or processing for a multiplicity of platforms, irrespective of differences in the respective platforms' infrastructures and content offerings. For instance, if the word association game were hosted at provider 720, then the back end processing and scoring functionality to enhance the user experience may be limited to that particular game, even in cases where users of many platforms 710 may have access to the game. On the other hand, where the game is hosted at platforms 710, then provider 720 resources (that would otherwise be required for hosting the game) may be made available such that provider 720 may perform back end processing, analytics, ratings, and so forth for any number of other games or other content also hosted on platforms 710. In one example of this embodiment, provider 720 may be responsible for the accumulating (block 604) and selective distributing (block 605) operations depicted in FIG. 6, but not the other operations. In that regard, since provider 720 may aggregate and process data from a multiplicity of platforms 710, it may be desirable that provider 720 host contests or competitions based on those data, as set forth below.

Those of skill in the art will appreciate that such accumulating, back end processing, and selective distribution of data associated with scores or points, gifts, awards, “likes” or other approvals, and so forth may be centralized at provider 720, irrespective of the content, media, application, or process executing on platforms 710 that generated those data. The data processed at provider 720 may be employed, for example, to rate or rank users of platforms 710 in accordance with predetermined criteria, and may pit users against each other for bragging rights, cash awards, or other non-monetary prizes. In some instances, it may be desirable to group all of the users of each particular platform 710 together (with the understanding that many users are registered with multiple platforms) to acquire an aggregate score or point rating for each particular platform 710 as a whole. Platforms 710 may use these aggregate scores, for example, as business intelligence tools to monitor popularity, demographics, and other factors affecting the profitability of platform 710.

In one embodiment, provider 720 may require a user to register, such as described above with reference to FIG. 4. Upon registration, a user may be entitled to enter daily contests to win cash prizes based on the sum (or aggregate) of “likes,” “favorites,” “retweets,” and other accolades or approvals earned on popular social media platforms 710 and others. In this instance, the registration process, or the account management functionality described above, at provider 720 may require that the user provide a screen name, user identification code, or other identifying information that was used to register with each particular platform 710; alternatively, provider 720 may use identifying information (such as an e-mail address or uniform resource locator (URL), for example) provided by the user to identify registered accounts associated with the user at platforms 710 automatically or unassisted.

Provider 720 may offer a number of contests to registered users. In one implementation, two types of daily contests may be offered, one free and one requiring payment or upgrade as set forth above. It is noted that the frequency or periodicity of the contests may vary as desired, for example, in accordance with processing resources, user feedback, or a combination of these and other factors. In this example, free contests may be offered regularly, and while they may be implemented such that no cash or monetary prizes are awarded, they may allow users to become familiar with the ranking system, observe rankings and observe what sorts of behaviors affect ranking status, win entries into contests which would otherwise require a fee, and so forth. Paid contests may be implemented such that cash prizes may be awarded, but such contests may require payment or an unusually high point value or user score for contest entry.

In some embodiments, provider 720 may require membership fees (such as upon registration, and monthly or semi-monthly thereafter), fees to enter contests, or both. For example, it may be desirable to require that a user buy a monthly or yearly membership or subscription; such a membership may grant a user full access to all contests without a requirement to pay a per-contest entry fee during the term of the subscription. As another example, and similar to many fantasy sports groups or on-line media sites, registered users of provider 720 may join or otherwise be invited to individual cash contests; with a membership, such users may be required to pay an entry fee; such fee may vary as a function of the type or duration of the contest, the stakes, the nature of the group primarily associated with the contest, or a combination of these and other factors.

To ensure fairness, users may be required to compete only against others within the same range of friends, followers, colleagues, classmates, or other appropriate age, demographic, or socio-economic group. Once a user synchronizes a registered account at platform 710 with a registered account at provider 720, for example, matching algorithms or other processes executing at provider 720 may automatically group a user accordingly. Additionally or alternatively, a user may be requested or prompted to select a group or to provide additional information to enable accurate or fair grouping according to predetermined rules or criteria.

Provider 720 may apply hashtag or other multipliers to a particular score received by a user. In some instances, a multiplier may be applied to enhance the value or score that would otherwise have been received for the same content or interaction. For example, “likes,” “favorites,” “retweets,” or other approvals or accolades that are earned while using a certain hashtag or while identifying or associating certain content may be worth more points or value (as the multiplier is applied) than they otherwise would. Such a multiplier system may be used for popular hashtags such as #tbt or it may be used for sponsorships, advertising campaigns, charity events, political affiliations, or the like. For example, whereas a normal “like” or similar acknowledgement of approval may amount to one point on the system at provider 720, if an authorized hashtag or other content is associated with the approval, then a multiplier may be applied, bumping the approval value to 1.2×, 1.5×, 2×, etc. at provider 720.

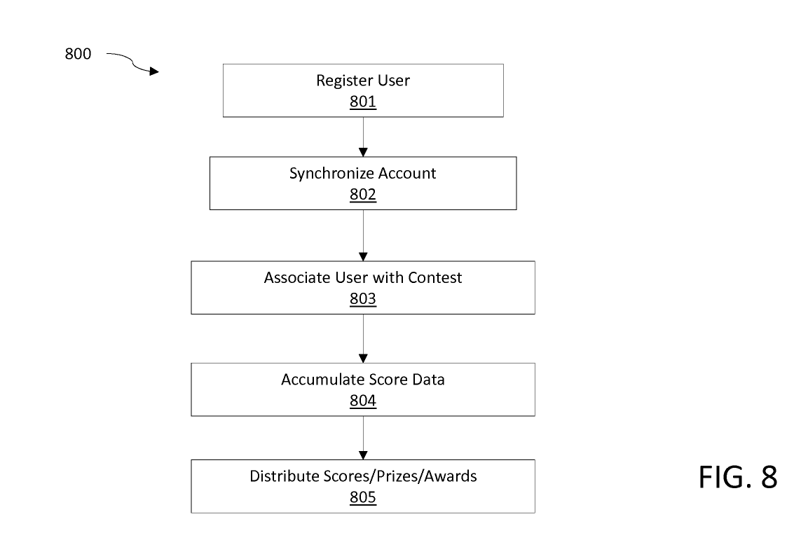

FIG. 8 is a simplified flow diagram illustrating operational flow of one embodiment of a social media system. As illustrated in FIG. 8, a method 800 may begin by registering a user of the system at block 801. Registration may be performed as set forth above, for example, or in accordance with various methodologies known in the art. Upon registration, method 800 may proceed by synchronizing a registered user account with an identified account at a social media platform as indicated at block 802. As set forth above, provider 720 may associate user data with other data maintained at platforms 710 for purposes of authenticating a user, acquiring score data for a registered user, and other purposes. In this context, therefore, “synchronizing” generally means associating data in a registered account at provider 720 with other data in a registered account for the same user at platform 710.

Upon request and subsequent confirmation that appropriate payment has been made and that account status allows, method 800 may continue by associating a user with a particular contest. As noted above, a user may not be eligible for a particular contest for a variety of reasons, including not having paid a membership fee, being delinquent on payments, not being in a group that is authorized to participate in the contest, and so forth. Where a user satisfies the requisite criteria, provider 720 may allow participation and begin accumulating score data as indicated at block 804.

As noted above, score data may be related to a sentence that is rated or ranked by reviewing users, for instance, or it may be related to any other content associated with the registered user and accessible by reviewing users on platforms 710. Photographs, blog entries, re-posts, or any other content that reviewing users “like” or otherwise approve on platforms 710 may accumulate points or scores at provider 720. Provider 720 may apply a multiplier factor (e.g., to raise or lower a point value as compared to a base point value) depending upon a variety of factors such as popularity or originality of the content, for example, or whether the content is associated with or includes particular sponsored material or content. It will be appreciated that the multiplier applied, if any, may be contest-specific.

At termination or expiration of the contest, method 800 may also conclude with selectively distributing final score values to all participants and distributing earned prizes or awards to the winner or winners as indicated at block 805. Distributing scores may be executed in a manner substantially similar to that described above with reference to FIG. 6. Distributing prizes and awards may be executed automatically or at the winner's request. This may include depositing funds or non-monetary points into a user account, mailing a cash payment, or utilizing another mechanism to provide the award to the winning user as may be predetermined or specified by the parameters of the contest.

The descriptions set forth above are meant to be illustrative and not limiting. Various modifications of the invention, in addition to those described herein, will be apparent to those skilled in the art from the foregoing description. Such modifications are also intended to fall within the scope of the concepts described herein. The disclosures of each patent, patent application and publication cited or described in this document are hereby incorporated herein by reference, in their entireties.

The foregoing description of possible implementations consistent with the present disclosure does not represent a comprehensive list of all such implementations or all variations of the implementations described. The description of some implementation should not be construed as an intent to exclude other implementations. For example, artisans will understand how to implement the invention in many other ways, using equivalents and alternatives that do not depart from the scope of the invention. Moreover, unless indicated to the contrary in the preceding description, none of the components described in the implementations are essential to the invention. It is thus intended that the embodiments disclosed in the specification be considered as illustrative, with a true scope and spirit of the invention being indicated by the following claims.

What is claimed is:

1. A computer-implemented method enabling a word association interaction between users; said method comprising:
presenting a list of words to a user;
receiving a sentence from the user and verifying that the sentence satisfies a verification criterion;
responsive to said verifying, displaying the sentence to a reviewing user;
accumulating score data received from the reviewing user and associated with the sentence; and
selectively distributing the score data.

2. The method of claim 1 wherein the verification criterion is a requirement that the sentence include a word from the list.

3. The method of claim 1 wherein said presenting comprises including a sponsored word in the list.

4. The method of claim 3 wherein the verification criterion is a requirement that the sentence include the sponsored word.

5. The method of claim 1 wherein said accumulating comprises computing a value representing a sum of every respective score received from every respective reviewing user.

6. The method of claim 1 wherein said selectively distributing comprises transmitting the score data to members of a group comprising the user.

7. The method of claim 1 wherein said selectively distributing comprises including the score data in a leaderboard interface.

8. A system enabling a word association interaction between users; said system comprising computer hardware and a computer-readable storage medium and operative to:
present a list of words to a user;
receive a sentence from the user and verify that the sentence satisfies a verification criterion;
responsive to verification, display the sentence to a reviewing user;
accumulate score data received from the reviewing user and associated with the sentence; and
selectively distribute the score data.

9. A computer-implemented method enabling competitive interaction between users; said method comprising: registering a user by establishing a registered user account; synchronizing the registered user account with an identified account at a social media platform associated with the user; associating the user with a particular contest; accumulating score data responsive to user interactions at the social media platform; and selectively distributing the score data and an award upon termination of the contest.

10. The method of claim 9 wherein said accumulating comprises selectively applying a multiplier value to individual scores associated with the user interactions.

11. The method of claim 9 wherein said registering comprises collecting a fee from the user.

12. The method of claim 9 wherein said associating comprises collecting a fee from the user.
